(19) United States
(12) Patent Application Publication
(10) Pub. No.: US 2006/0194551 A1
(43) Pub. Date: Aug. 31, 2006

(54) Power amplifier and polar modulation system

(75) Inventors: Yuji Sato, Kyoto (JP); Kunihiko Kanazawa, Kyoto (JP); Kazuki Tateoka, Kyoto (JP); Shingo Matsuda, Kyoto (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/359,597

(22) Filed: Feb. 23, 2006

(30) Foreign Application Priority Data
Feb. 25, 2005 (JP) 2005-050782

(51) Int. Cl. H04B 1/04; H01Q 11/12

(52) U.S. Cl. 455/127.1

(57) ABSTRACT

The power amplifier of the present invention is a power amplifier used in a communication device which communicates in a plurality of transmission modes of different power levels while switching the power level from mode to mode, and includes: an input terminal to which a signal is inputted; a first amplification unit for amplifying the signal inputted to the input terminal to a signal of a first power level; and a second amplification unit for amplifying the signal inputted to the input terminal to a signal of a second power level which is different from the first power level, wherein when one of the first amplification unit and the second amplification unit is turned on, the other is turned off.

### BACKGROUND OF THE INVENTION

(1) Field of the Invention

The present invention relates to a power amplifier and a polar modulation system, and particularly to a power amplifier used for a communication device which communicates in a plurality of transmission modes of different power levels while switching the power level from mode to mode.

(2) Description of the Related Art

In a wireless communication system, there has been a demand for a wireless communication device which supports various modulations. Such device is, for example, a cellular phone which supports a time division multiple access (TDMA) operation mode and a code division multiple access (CDMA) operation mode.

Each modulation requires its own power level and the like to be used. Therefore, the power amplifier of such wireless communication device needs to efficiently amplify a signal of a power level which complies with each modulation. As a method for allowing a power amplifier to support various modulations, a method of changing the impedance at the output side of the power amplifier is well known (see, for example, Patent Reference 1: Japanese Laid-Open Patent Application No. 2001-251202 Publication).

FIG. 1 is a block diagram showing a structure of a power amplifier described in Patent Reference 1.

The power amplifier shown in FIG. 1 includes a power supply and bias control unit 24, a linear power amplifier 25, a microprocessor 26, a modulation format switch 27, a control unit 28 and a load 29.

According to this structure, the impedance at the output side of the power amplifier 25 is switched, using the modulation format switch 27, depending on a system (transmission scheme) such as CDMA and TDMA, and therefore the efficiency and/or linearity of the linear power amplifier 25 can be enhanced.

### SUMMARY OF THE INVENTION

The conventional power amplifier has a structure in which the impedance at the output side of the power amplifier is switched using a switch depending on a system. Therefore, if the required output power level varies from system to system, it is difficult to maximize the efficiency for each system because only one amplifier is used for all the systems which require different output power levels. This is a problem.

For example, the case where power is amplified so as to output a signal of a higher power level and a signal of a lower power level is described below. In such case, the linear power amplifier 25 is structured so as to have the capability of supporting the amplification of the signal of the higher power level, in order to output the signals of these two power levels. In the case where the power amplifier outputs the signal of the higher power level, it is possible to optimize the efficiency of the linear power amplifier 25 by selecting the impedance equivalent to the output impedance of the linear power amplifier 25 using the modulation format switch 27. On the other hand, in the case where it outputs the signal of the lower power level, it is possible to enhance the efficiency of the linear power amplifier 25 by increasing the impedance at its output side, using the modulation format switch 27. However, since the capability of the linear power amplifier 25 is optimized for the case of the higher output power level, the optimum efficiency cannot be obtained in the case of the lower output power level. This is the problem of the conventional power amplifier that it is difficult to maximize the efficiency for each system.

In order to solve the above problem, it is an object of the present invention to provide a power amplifier and a polar modulation system capable of maximizing their efficiencies in the case where signals of various power levels are outputted.

In order to achieve the above object, the power amplifier of the present invention is a power amplifier used in a communication device which communicates in a plurality of transmission modes of different power levels while switching the power level from mode to mode, the power amplifier including: an input terminal to which a signal is inputted; a first amplification unit operable to amplify the signal inputted to the input terminal to a signal of a first power level; and a second amplification unit operable to amplify the signal inputted to the input terminal to a signal of a second power level which is different from the first power level, wherein when one of the first amplification unit and the second amplification unit is turned on, the other is turned off. Here, a transmission mode means a form of a signal to be used for sending and receiving. For example, a difference in a transmission mode means a difference in a transmission scheme (such as CDMA and TDMA), a difference in a power level of a signal to be used for sending and receiving in the same transmission scheme, and the like.

The power amplifier of the present invention structured as mentioned above is capable of switching between amplification units to be used, depending on the power level of a signal to be outputted. Therefore, the power amplifier of the present invention optimizes each amplification unit for each power level of a signal to be outputted, so that the efficiency can be maximized in the case of outputting signals of various power levels.

The first amplification unit and the second amplification unit may perform nonlinear amplification of the signals, and the first amplification unit and the second amplification unit may each output a signal of a desired power level according to control of a power supply voltage to be applied.

The power amplifier of the present invention structured as mentioned above can be designed without any regard for its linearity. In other words, it becomes possible to design a power amplifier easily.

The above-mentioned power amplifier may further include: an output terminal operable to output one of the signals amplified by the first amplification unit and the second amplification unit; a first input matching unit operable to perform matching between an output impedance of a signal source which outputs the signal inputted to the input terminal and an input impedance of the first amplification unit; a second input matching unit operable to perform matching between the output impedance of the signal source and an input impedance of the second amplification unit; a first output matching unit operable to perform matching between an output impedance of the first amplification unit and an impedance of a load connected to the output terminal; and a second output matching unit operable to perform matching between an output impedance of the second amplification unit and the impedance of the load.

The power amplifier of the present invention structured as mentioned above is capable of performing impedance matching for the input and output of each of the first and second amplification units. Therefore, the transmission efficiency is optimized.

The input impedance of the first amplification unit may be different from the input impedance of the second amplification unit, and the output impedance of the first amplification unit may be different from the output impedance of the second amplification unit.

The first and second amplification units structured as mentioned above are capable of amplifying respective signals of different power levels at the maximum efficiencies.

The first amplification unit and the second amplification unit may amplify signals used in the same transmission scheme.

In the case where the power amplifier of the present invention structured as mentioned above is used for outputting signals of different power levels in the same transmission scheme, the efficiency can be maximized.

At least one of the first amplification unit and the second amplification unit may be made up of amplification units in a multiple-stage structure.

In at least one of the first and second amplification units, the maximum output power level can be increased. In addition, the variable range of output power levels can be expanded.

The above-mentioned power amplifier may further include: a first output terminal operable to output the signal amplified by the first amplification unit; and a second output terminal operable to output the signal amplified by the second amplification unit.

According to this structure, the signals outputted from the first and second amplification units can respectively be outputted to different output terminals.

The above-mentioned power amplifier may further include an output terminal operable to output the signals amplified by the first amplification unit and the second amplification unit.

According to this structure, the signals amplified by the first and second amplification units are outputted to one output terminal.

The above-mentioned power amplifier may further include a switch which is connected between an output of the second amplification unit and the output terminal, wherein an output of the first amplification unit is connected to the output terminal; and wherein the switch is turned off when the first amplification unit is in an on-state, and turned on when the second amplification unit is in an on-state.

According to this structure, in the case where the first amplification unit is used, the influence of the output load of the second amplification unit can be reduced. In addition, in the case where the first amplification unit is used, it is possible to prevent the signal amplified by the first amplification unit from going from the output of the second amplification unit to the input of the first amplification unit. Furthermore, since the output of the first amplification unit is connected directly to the output terminal not via a switch, the transit loss of this path can be reduced, compared with that of the output path of the second amplification unit.

The above-mentioned power amplifier may further include a switch which is connected between the output terminal and outputs of the first amplification unit and the second amplification unit, wherein the switch connects the output terminal to one of the outputs of the first amplification unit and the second amplification unit.

According to this structure, in the case where the first amplification unit is used, the influence of the output load of the second amplification unit can be reduced. In addition, in the case where the second amplification unit is used, the influence of the output load of the first amplification unit can be reduced.

The above-mentioned power amplifier may further include a switch which is connected between the input terminal and at least one of inputs of the first amplification unit and the second amplification unit.

According to this structure, in the case where one of the first and second amplification units is used, the influence of the input load of the other one can be reduced.

The first amplification unit and the second amplification unit may each be made up of one of a bipolar transistor and a field-effect transistor; and the first amplification unit and the second amplification unit may each be controlled to be turned on or off according to control of one of a base voltage of the bipolar transistor and a gate voltage of the field-effect transistor.

According to this structure, it becomes possible to switch ON/OFF of the first and second amplification units according to control of the base voltage of the bipolar transistor or the gate voltage of the field effect transistor.

The first amplification unit and the second amplification unit may each have a control terminal of one of the base voltage of the bipolar transistor and the gate voltage of the field-effect transistor.

According to this structure, it becomes possible to switch ON/OFF of the first and second amplification units according to control of the voltage to be applied to the control terminals of the first and second amplification units.

The above-mentioned power amplifier may further include a third amplification unit which is provided between the input terminal and inputs of the first amplification unit and the second amplification unit.

The power amplifier of the present invention structured as mentioned above includes the third amplification unit in the stage previous to that of the first and second amplification units, so that the maximum output power level can be increased. In addition, the variable range of output power levels can be expanded. Furthermore, the common use of the third amplification unit reduces the circuit size.

The above-mentioned power amplifier may include a plurality of amplification units which include at least the first amplification unit and the second amplification unit, and are operable to amplify the signal inputted to the input terminal to signals of power levels which are different from each other, wherein when one of the plurality of amplification units is turned on, the other is turned off.

According to this structure, each amplification unit is optimized for the signal level of a signal to be outputted, so that respective efficiencies can be maximized in the case where signals of various power levels are outputted.

In addition, the polar modulation system of the present invention includes: a radio frequency integrated circuit operable to separate an IQ signal into phase information and amplitude information, and to output the phase information and the amplitude information; a power supply circuit operable to output a voltage corresponding to the amplitude information; a first amplification unit operable to amplify the phase information to a signal of a first power level; and a second amplification unit operable to amplify the phase information to a signal of a second power level which is different from the first power level, wherein when one of the first amplification unit and the second amplification unit is turned on, the other is turned off; and wherein the voltage outputted by the power supply circuit is inputted, as a power supply voltage, to the first amplification unit and the second amplification unit.

According to this configuration, it is possible to switch an amplification unit to be used, depending on the power level of a signal to be outputted. Therefore, in the polar modulation system of the present invention, each amplification unit is optimized for the signal level of a signal to be outputted, so that respective efficiencies can be maximized in the case where signals of various power levels are outputted.

Furthermore, the control method of the present invention is a method for controlling a power amplifier used in a communication device which communicates in a plurality of transmission modes of different power levels while switching the power level from mode to mode, the method including turning on one of two amplification units operable to amplify the same signal to signals of power levels which are different from each other.

According to the power amplifier control method of the present invention, it is possible to switch an amplification unit to be used, depending on the power level of a signal to be outputted. Therefore, according to this power amplifier control method, it is possible to optimize each amplification unit for the power level of a signal to be outputted, so that respective efficiencies can be maximized in the case where signals of various power levels are outputted.

As described above, it is possible to embody the present invention not only as such power amplifier but also as a power amplifier control method that includes, as its steps, the characteristic units included in such power amplifier.

As described above, according to the power amplifier of the present invention, it is possible to maximize respective efficiencies in the case a plurality of signals of different power levels are outputted.

As further information about technical background to this application, the disclosure of Japanese Patent Application No. 2005-050782 filed on Feb. 25, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of a conventional power amplifier;

FIG. 2 is a block diagram of a power amplifier in a first embodiment of the present invention;

FIG. 3 is a circuit diagram of the power amplifier in the first embodiment of the present invention;

FIG. 4 is a block diagram of another example of the power amplifier in the first embodiment of the present invention;

FIG. 5 is a block diagram of still another example of the power amplifier in the first embodiment of the present invention;

FIG. 6 is a block diagram of a power amplifier in a second embodiment of the present invention;

FIG. 7 is a block diagram of another example of the power amplifier in the second embodiment of the present invention;

FIG. 8 is a block diagram of a power amplifier in a third embodiment of the present invention;

FIG. 9 is a block diagram of another example of the power amplifier in the third embodiment of the present invention;

FIG. 10 is a block diagram of a polar modulation system including the power amplifier of the present invention;

FIG. 11 is a diagram showing an IQ signal in the polar modulation system; and

FIG. 12 is a diagram showing the amplitude/phase conversion of the IQ signal.

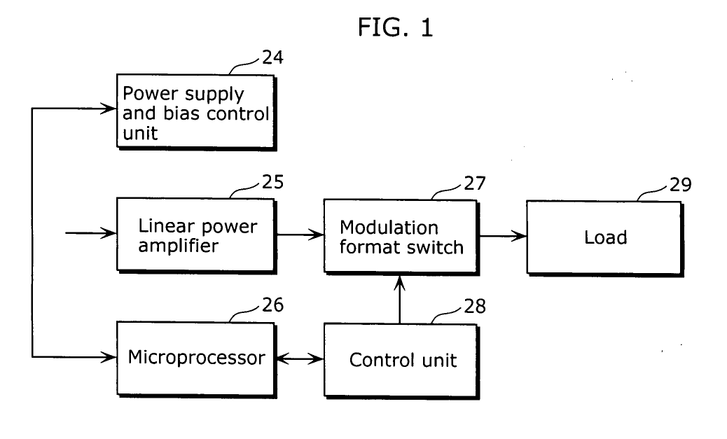

### DESCRIPTION OF THE PREFERRED EMBODIMENT(S)

The best mode for carrying out the present invention is described below with reference to the diagrams.

### First Embodiment

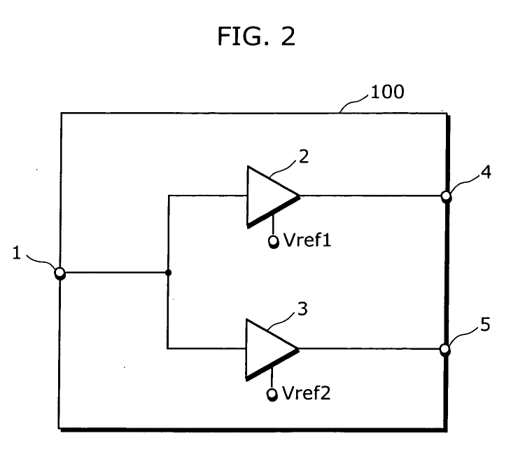

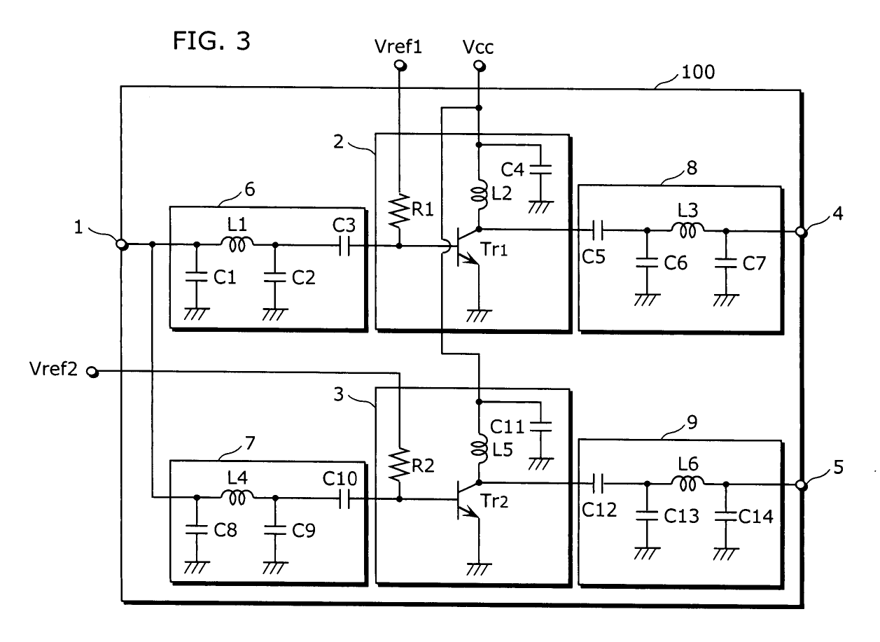

The power amplifier in the first embodiment of the present invention is described with reference to FIG. 2 and FIG. 3. Since the power amplifier in the first embodiment includes a plurality of amplification units optimized for respective systems, it is capable of maximizing the efficiency in each of these systems.

FIG. 2 is a block diagram of the power amplifier in the first embodiment of the present invention, and FIG. 3 is a circuit diagram showing constituent elements of each block in FIG. 2. As shown in FIG. 2, the power amplifier 100 includes an input terminal 1, rear amplification units 2 and 3, and output terminals 4 and 5. The power amplifier 100 amplifies a signal inputted into the input terminal 1, and outputs the signal to the output terminal 4 or 5. A signal of an arbitrary frequency is inputted into the input terminal 1 and the output of the signal is divided into two. One of the divided outputs is connected to the input of the rear amplification unit 2, and the other is connected to the input of the rear amplification unit 3. The output of the rear amplification unit 2 is connected to the output terminal 4, and the output of the rear amplification unit 3 is connected to the output terminal 5. In addition, it is assumed that a signal of a high power level is outputted to the output terminal 4, and a signal of a low power level is outputted to the output terminal 5.

The rear amplification unit 2 amplifies a signal inputted to the input terminal 1 into a signal of a high power level. The rear amplification unit 2 is optimized for the amplification of a high power signal, and is turned on or off according to a signal of a Vref1 terminal.

The rear amplification unit 3 amplifies the signal inputted to the input terminal 1 into a signal of a low power level which is different from the power level of the signal outputted from the rear amplification unit 2. The rear amplification unit 3 is optimized for the amplification of a low power signal, and is turned on or off according to a signal of a Vref2 terminal. When one of the rear amplification units 2 and 3 is turned on, the other is turned off.

In the case where a high power signal is inputted into the input terminal 1, the rear amplification unit 2 is turned on, while the rear amplification unit 3 is turned off. Therefore, in the case where a high power signal is inputted into the input terminal 1, the rear amplification unit 2 amplifies the signal inputted into the input terminal 1 and outputs the signal to the output terminal 4.

In the case where a low power signal is inputted into the input terminal 1, the rear amplification unit 2 is turned off, while the rear amplification unit 3 is turned on. Therefore, in the case where a low power signal is inputted into the input terminal 1, the rear amplification unit 3 amplifies the signal inputted into the input terminal 1 and outputs the signal to the output terminal 5.

An antenna, for example, is connected to the output terminals 4 and 5.

FIG. 3 shows a detailed circuit of the block diagram of FIG. 2. In FIG. 3, the output of the input terminal 1 is divided into two, and one of the divided outputs is connected to the base of a transistor Trn via a matching circuit 6. In the following description, it is assumed that high frequency bipolar transistors are used as transistors. Note that a field-effect transistor may substitute for a bipolar transistor.

The matching circuit 6 includes a capacitor C1, a capacitor C2, an inductor L1 and a capacitor C3. The matching circuit 6 performs impedance matching between the impedance of a circuit, a wiring or the like connected to the input terminal 1 (for example, an output impedance of a signal source which outputs the signal inputted to the input terminal 1) and the input impedance of the rear amplification unit 2. For example, assuming that the wiring with an impedance 50Q is connected to the input terminal 1 and the input impedance of the rear amplification unit 2 is 3Ω, the matching circuit 6 performs impedance conversion from 50Ω into 3Ω.

The rear amplification unit 2 includes a transistor Tr1, a resistance R1, a capacitor C4 and an inductor L2. As for the transistor Tr1, the emitter is grounded, a voltage suitable for a mode signal of a system is applied to Vref1 from outside and then applied, as a bias voltage, to the base via the resistance R1, and a voltage Vcc bypassed by the capacitor C4 is applied to the collector via the inductor L2 that is the load. ON/OFF of the rear amplification unit 2 is controlled based on the base voltage of the transistor Tr1. More specifically, the rear amplification unit 2 is turned on when the voltage for turning on the transistor Tr1 is applied to Vref1, while it is turned off when the voltage 0V is applied to Vref1 or Vref1 is grounded. The rear amplification unit 2, in its ON state (a state in which the voltage for turning on the transistor Tr1 is applied to Vref1), amplifies the signal obtained by the impedance matching by the matching circuit 6, and outputs it to the matching circuit 8.

The matching circuit 8 includes a capacitor C5, a capacitor C6, an inductor L3 and a capacitor C7. The matching circuit 8 performs impedance matching between the output impedance of the rear amplification unit 2 and the impedance of the load, that is, a circuit, a wiring or the like (for example, an antenna) connected to the output terminal 4. For example, assuming that the output impedance of the rear amplification unit 2 is 3Ω and the impedance of the antenna connected to the output terminal 4 is 50Ω, the matching circuit 8 performs impedance conversion from 3Ω into 50Ω.

The other one of the divided outputs from the input terminal 1 is connected to the base of the transistor Tr2 via the matching circuit 7.

The matching circuit 7 includes a capacitor C8, a capacitor C9, an inductor L4 and a capacitor C10. The matching circuit 7 performs impedance matching between the impedance of the circuit or the wiring connected to the input terminal 1 and the input impedance of the rear amplification unit 3. Since the rear amplification units 2 and 3 are optimized for signals of different power levels, their input impedance values are different from each other. For example, assuming that the wiring of the impedance 50Ω is connected to the input terminal 1 and the input impedance of the rear amplification unit 3 is 7Ω, the matching circuit 7 performs impedance conversion from 50Ω to 7Ω.

The rear amplification unit 3 includes a transistor Tr2, a resistance R2, a capacitor C11 and an inductor L5. As for the transistor Tr2, the emitter is grounded, a voltage suitable for a mode signal of a system is applied to Vref2 from outside and then applied, as a bias voltage, to the base via the resistance R2, and a voltage Vcc bypassed by the capacitor C11 is applied to the collector via the inductor L5 that is the load. ON/OFF of the rear amplification unit 3 is controlled based on the base voltage of the transistor Tr2. More specifically, the rear amplification unit 3 is turned on when the voltage for turning on the transistor Tr2 is applied to Vref2, while it is turned off when the voltage 0V is applied to Vref2 or Vref2 is grounded. The rear amplification unit 3, in its ON state (a state in which the voltage for turning on the transistor Tr2 is applied to Vref2), amplifies the signal obtained by the impedance matching by the matching circuit 7, and outputs it to the matching circuit 9.

The matching circuit 9 includes a capacitor C12, a capacitor C13, an inductor L6 and a capacitor C14. The matching circuit 9 performs impedance matching between the output impedance of the rear amplification unit 3 and the impedance of the load, that is, a is circuit, a wiring or the like (for example, an antenna) connected to the output terminal 5. Since the rear amplification units 2 and 3 are optimized for signals of different power levels, their output impedance values are different from each other. For example, assuming that the output impedance of the rear amplification unit 3 is 7Q and the impedance of the antenna connected to the output terminal 5 is 50ΩQ, the matching circuit 9 performs impedance conversion from 7Ω to 50Ω.

The operation of the above-structured power amplifier 100 in the present embodiment is described below.

For example, it is assumed here that two systems supported by this power amplifier 100 are Global System for Mobile Communications (GSM) using a high power signal and Wideband Code Division Multiple Access (WCDMA) using a low power signal. First, in order to amplify a GSM signal, a voltage for turning on the transistor Tr1 is applied to the rear amplification unit 2 through Vref1, and a voltage 0V is applied to the rear amplification unit 3 through Vref2 or Vref2 is grounded so as to turn off the transistor Tr2. Since the transistor Tr1 is in the ON state, the GSM signal inputted into the input terminal 1 is inputted into the matching circuit 6 for impedance matching, and then outputted to the rear amplification unit 2. The signal inputted into the rear amplification unit 2 is amplified, outputted to the matching circuit 8 for impedance matching, and then outputted to the output terminal 4. Note that although the transistor Tr1 performs a nonlinear amplification of the signal, the power supply voltage Vcc to be applied to its collector is controlled so that a signal of a desired power level can be outputted.

In order to amplify a WCDMA signal, a voltage for turning on the transistor Tr2 is applied to the rear amplification unit 3 through Vref2, and a voltage 0V is applied to the rear amplification unit 2 through Vref1 or Vref1 is grounded so as to turn off the transistor Tr1. Since the transistor Tr2 is in the ON state, the WCDMA signal inputted into the input terminal 1 is inputted into the matching circuit 7 for impedance matching, and then outputted to the rear amplification unit 3. The signal inputted into the rear amplification unit 3 is amplified, outputted to the matching circuit 9 for impedance matching, and then outputted to the output terminal 5. Note that although the transistor Tr2 performs a nonlinear amplification of the signal, the power supply voltage Vcc to be applied to its collector is controlled so that a signal of a desired power level can be outputted.

Accordingly, the power amplifier 100 in the present embodiment is capable of maximizing the efficiency of each system by switching the amplification unit depending on a system.

The power amplifier according to one embodiment of the present invention has been described, but the present invention is not limited to this embodiment.

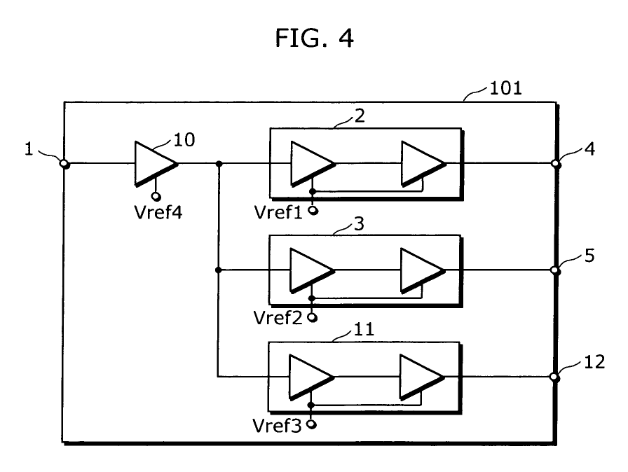

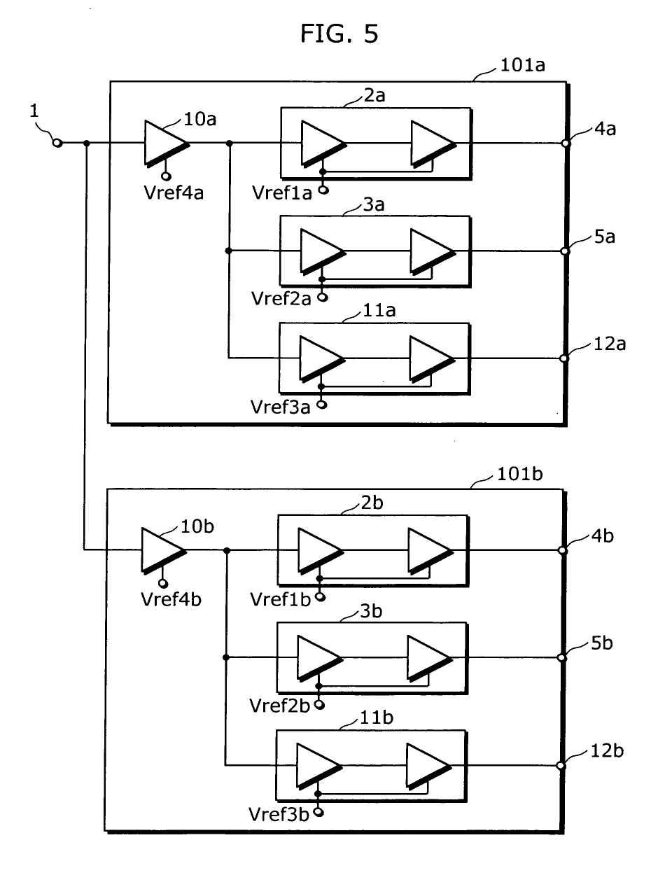

FIG. 4 and FIG. 5 are diagrams showing modifications of the power amplifier 100 in the first embodiment.

Although the output of the input terminal 1 is divided into two in the above embodiment, it is possible, like a power amplifier 101 as shown in FIG. 4, to divide the output of the input terminal 1 into three and to connect the rear amplification units 2, 3 and 11 between these divided outputs and the output terminals 4, 5 and 12 one on one. It is also possible to add rear amplification units of the number of the divided outputs so that the power amplifier of the present invention can be used for n (three or more) systems. In other words, the power amplifier of the present invention may include a plurality of rear amplification units which respectively amplify a signal inputted into the input terminal 1 into signals of different power levels. In such case, when one of these rear amplification units is turned on, the others are turned off.

Although only one amplification unit (namely, a single-stage amplification unit) is included in each rear amplification unit of the above embodiment, it is possible to increase the number of stages, for example, two stages like the power amplifier 101 shown in FIG. 4 or n (three or more) stages, so that the maximum output power level can be increased and the variable range of output power levels can be expanded. Furthermore, in the power amplifier 101 shown in FIG. 4, all the rear amplification units 2, 3 and 11 have a two-stage structure, but the number of stages may vary from unit to unit. For example, it is possible that the rear amplification units 2 and 3 each have a two-stage structure, while the rear amplification unit 11 has a single-stage structure.

Although the inputs of the rear amplification units 2 and 3 are connected to the input terminal 1 in the above embodiment, a front amplification unit may be provided between the input terminal 1 and the inputs of the rear amplification units. If a front amplification unit 10 is provided between the input terminal 1 and the divided outputs thereof like the power amplifier 101 shown in FIG. 4, it becomes possible to increase the maximum output power level without increasing the number of stages of each rear amplification unit as well as to expand the variable range of output power levels. In addition, since the front amplification unit 10 is used in common for the output of any power level, the circuit size can be reduced.

The front amplification unit 10 and the rear amplification units 2, 3 and 11 included in the power amplifier 101 shown in FIG. 4 have the terminals Vref1 to Vref4 respectively for controlling the base voltage of the transistor Tr1. When the power amplifier 101 is used, it is possible to bring a desired path into an operable state by applying a voltage for activating the front amplification unit 10 to Vref4 all the time, while applying a voltage for activating one of the rear amplification units 2, 3 and 11 to Vref1, Vref2 or Vref3 as needed.

Although a plurality of amplification units are used respectively for supporting different systems in the above embodiment, the present invention is not limited to such use. The present invention can be used for the case where various output power levels are required for one system (transmission scheme). For example, the present invention can also be used for a wireless communication system for a cellular phone and the like in which the power level of a signal to be transmitted is changed according to the distance from a base station (more specifically, a system in which the power level is increased if the cellular phone is far from the base station and decreased if it is near the base station).

It is also possible, as shown in FIG. 5, to include a plurality of power amplifiers 101 of FIG. 4. For example, if a power amplifier 101a is used for amplification of a GMS signal and a power amplifier 101b is used for amplification of a WCDMA signal, rear amplification units 2a, 3a, 11a, 2b, 3b and 11b of these power amplifiers 101a and 101b are respectively able to amplify such signals into signals of different power levels. When the power amplifier 101a is used, the power amplifier 101b can be turned off by applying the voltage 0V to Vref1b to Vref4b or grounding them. When the power amplifier 101b is used, the power amplifier 101a can be turned off by applying the voltage 1V to Vref1a to Vref4a or grounding them. Note that since the rear amplification units of the power amplifiers 101a and 101b are turned on or off in the same manner as those of the power amplifier 101 shown in FIG. 4, the description thereof is not repeated here.

### Second Embodiment

A power amplifier in the second embodiment of the present invention is described below with reference to FIG. 6. The power amplifier in the second embodiment includes a switch placed between the outputs of a plurality of amplification units so as to prevent one amplification unit from being affected by the other amplification unit even if the power amplifier has only one output terminal.

FIG. 6 is a block diagram of the power amplifier in the second embodiment of the present invention. This power amplifier differs from the power amplifier shown in FIG. 2 in that it has only one output terminal and the output of one rear amplification unit is connected directly to the output terminal while the output of the other rear amplification unit is connected to the output terminal via a switch. Since the circuit operation of the power amplifier in the present embodiment is same as that in the first embodiment, the same reference numbers are assigned and the description thereof is not repeated here.

As shown in FIG. 6, a signal of an arbitrary frequency is inputted into the input terminal 1, and the output from the input terminal 1 is divided into two and the divided outputs are connected to the rear amplification units 2 and 3 for amplifying these signals. The output of the rear amplification unit 2 is connected to the output terminal 4. A switch 13 is connected between the output of the rear amplification unit 3 and the output terminal 4. For example, the switch 13 is a semiconductor switch which uses a PIN diode, a bipolar transistor, a field-effect transistor, a high electron mobility transistor (HEMT) or the like.

The operation of the above-structured power amplifier of the present embodiment is described below.

For example, it is assumed here that two systems supported by this power amplifier are GSM using a high power signal and WCDMA using a signal of a lower power level than that of the GSM signal. First, in order to amplify a GSM signal, the rear amplification unit 2 is turned on, the rear amplification unit 3 is turned off, and the switch 13 is turned off. The GSM signal inputted from the input terminal 1 is inputted into the rear amplification unit 2, amplified there, and then outputted to the output terminal 4, because the rear amplification unit 2 is in the ON state.

In order to amplify a WCDMA signal, the rear amplification unit 2 is turned off, the rear amplification unit 3 is turned on, and the switch 13 is turned on. The WCDMA signal inputted from the input terminal 1 is inputted into the rear amplification unit 3, amplified there, and then outputted to the output terminal 4 via the switch 13, because the rear amplification unit 3 is in the ON state. Note that although at least the rear amplification units 2 and 3 perform nonlinear amplification of the signals, the power supply voltages to be applied to them are controlled so that signals of desired power levels can be obtained respectively.

Accordingly, by placing the switch 13 at the output side of the rear amplification unit 3, it becomes possible to reduce the influence of the output load of the rear amplification unit 3 on the output load of the rear amplification unit 2 when the rear amplification unit 2 is in the ON state. It is also possible to prevent the high power signal amplified by the rear amplification unit 2 from feeding back from the output side of the rear amplification unit 3 to the input side of the rear amplification unit 2. In addition, since the rear amplification unit 2 and the output terminal 4 are directly connected to each other not via a switch, the transit loss of the path going through the rear amplification unit 2 is smaller than that of the path going through the rear amplification unit 3. Therefore, it is desirable to set which should be used, the rear amplification unit 2 or 3, depending on the characteristics of a system to be used. In other words, by not placing a switch on the path going through the rear amplification unit 2 which amplifies a high power signal but placing a switch on the path going through the rear amplification unit 3 which amplifies a low power signal, it is possible to prevent the high power signal amplified by the rear amplification unit 2, having a significant influence, from feeding back from the output side of the rear amplification unit 3 to the input side of the rear amplification unit 2. It is also possible to reduce the transit loss of the path of such high power signal because a switch is not provided on this path.

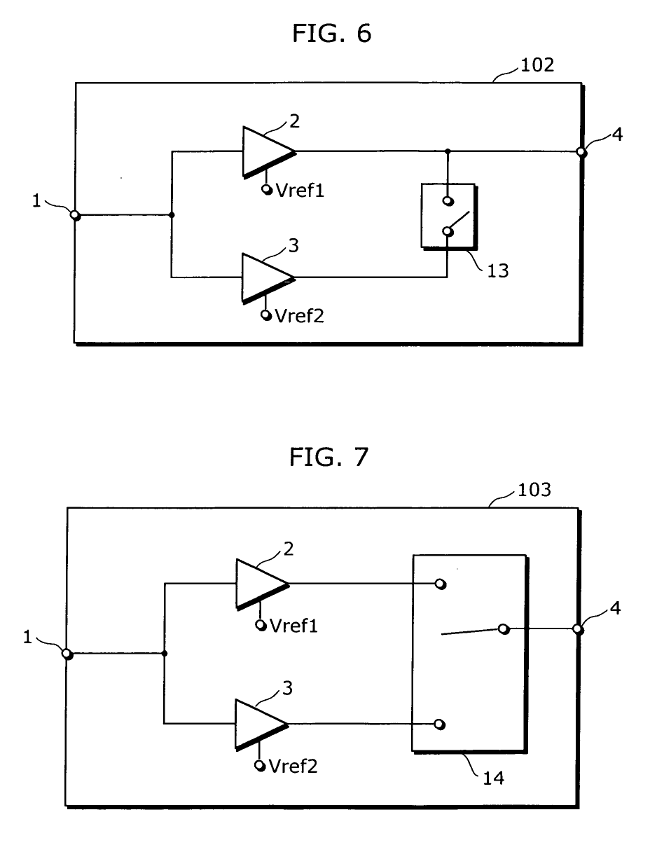

FIG. 7 is a block diagram showing a structure of a modification of the power amplifier in the second embodiment.

The switch 13 is an SPST switch in the above embodiment, but a switch 14 that is an SPDT switch may be used as shown in FIG. 7. The switch 14 is connected between the outputs of the rear amplification units 2 and 3 and the output terminal 4. The switch 14 allows one of the outputs of the rear amplification units 2 and 3 to be connected to the output terminal 4. The switch 14 connects the output of the rear amplification unit 2 to the output terminal 4 when the rear amplification unit 2 is in the ON state, and the switch 14 connects the output of the rear amplification unit 3 to the output terminal 4 when the rear amplification unit 3 is in the ON state. The use of such SPDT switch reduces the interference of one rear amplification unit with the output load of the other rear amplification unit during its ON state.

Although the output of the input terminal 1 is divided into two in the above embodiment, it is possible to add rear amplification units of the number of the divided outputs so that the power amplifier of the present invention can be used for n (three or more) systems. Although only one amplification unit (namely, a single-stage amplification unit) is included in each rear amplification unit of the above embodiment, it is possible to increase the number of stages, namely, to include n (two or more) amplification units, and therefore to increase the maximum output power level and expand the variable range of output power levels.

In addition, although the output of the input terminal 1 is divided in the above embodiment, the front amplification unit 10 may be provided between the input terminal 1 and the divided outputs thereof as shown in FIG. 4. By doing so, it becomes possible to increase the maximum output power level without increasing the number of stages of each rear amplification unit as well as to expand the variable range of output power levels.

### Third Embodiment

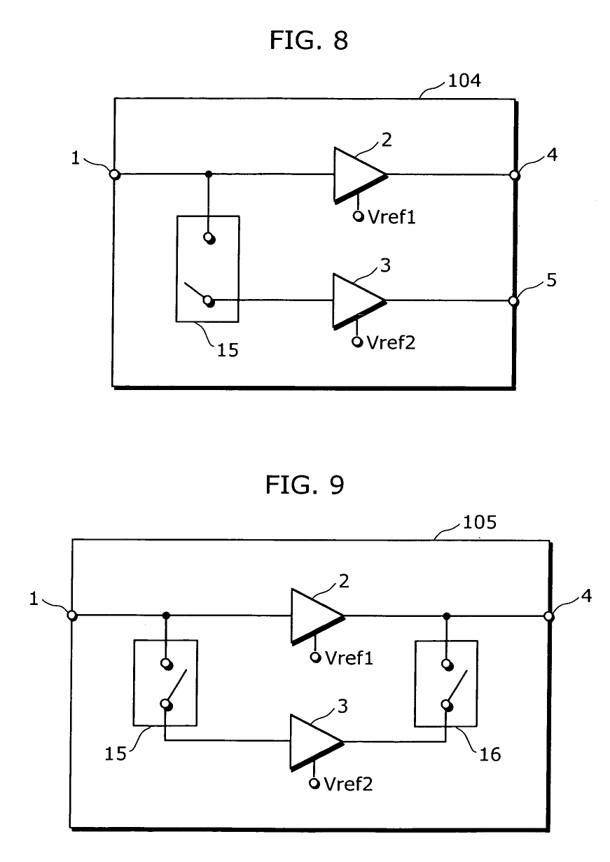

A power amplifier in the third embodiment is described below with reference to FIG. 8. The power amplifier in the third embodiment includes a switch between the inputs of a plurality of rear amplification units so as to prevent one rear amplification unit from being affected by the input impedance of the other rear amplification unit.

FIG. 8 is a block diagram of the power amplifier in the third embodiment of the present invention. This power amplifier differs from the power amplifier of the first embodiment in that the output of the input terminal is divided using a switch. Since the circuit operation in the present embodiment is same as that of the power amplifier in the first embodiment, the same reference numbers are assigned and the description thereof is not repeated here.

As shown in FIG. 8, a signal of an arbitrary frequency is inputted into the input terminal 1, and the output from the input terminal 1 is divided into two. One of the divided outputs is connected to the input of the rear amplification unit 2. A switch 15 is connected between the other one of the divided outputs and the input of the rear amplification unit 3. The output of the rear amplification unit 2 is connected to the output terminal 4, and the output of the rear amplification unit 3 is connected to the output terminal 5. For example, the switch 15 is a semiconductor switch which uses a PIN diode, a bipolar transistor, a field-effect transistor, a high electron mobility transistor (HEMT) or the like.

The operation of the above-structured power amplifier of the present embodiment is described below.

For example, it is assumed here that two systems supported by this power amplifier are GSM using a high power signal and WCDMA using a signal of a lower power level than that of the GSM signal. First, in order to amplify a GSM signal, the rear amplification unit 2 is turned on, the rear amplification unit 3 is turned off, and the switch 15 is turned off. The GSM signal inputted from the input terminal 1 is inputted into the rear amplification unit 2, amplified there, and then outputted to the output terminal 4, because the rear amplification unit 2 is in the ON state and the switch 15 is in the OFF state.

In order to amplify a WCDMA signal, the rear amplification unit 2 is turned off, the rear amplification unit 3 is turned on, and the switch 15 is turned on. The WCDMA signal inputted from the input terminal 1 is inputted into the rear amplification unit 3, amplified there, and then outputted to the output terminal 5, because the rear amplification unit 3 is in the ON state and the switch 15 is in the ON state. Note that although at least the rear amplification units 2 and 3 perform nonlinear amplification of the signals, the power supply voltages to be applied to them are controlled so that desired output power levels can be obtained respectively.

Accordingly, by placing the switch 15 at the output side of the input terminal 1, it becomes possible to reduce the influence of the input load of the rear amplification unit 3 on the input load of the rear amplification unit 2 when the rear amplification unit 2 is in the ON state. In addition, since the input terminal 1 and the input of the rear amplification unit 2 are directly connected to each other, the transit loss of the path going through the rear amplification unit 2 is smaller than that of the path going through the rear amplification unit 3. Therefore, it is desirable to set which should be used, the rear amplification unit 2 or 3, depending on the characteristics of a system to be used. In other words, by not placing a switch on the input path into the rear amplification unit 2 which amplifies a high power signal having a significant influence, but placing a switch 15 on the input path into the rear amplification unit 3 which amplifies a low power signal, it is possible to reduce the influence of the load of the rear amplification unit 3 on the amplification of a high power signal. It is also possible to reduce the transit loss of the input path of such high power signal because a switch is not provided on that path.

The switch 15 is an SPST switch in the above embodiment, but an SPDT switch may be used. An SPDT switch connects the input terminal 1 and the input of the rear amplification unit 2 when the rear amplification unit 2 is in the ON state. The SPDT switch connects the input terminal 1 and the input of the rear amplification unit 3 when the rear amplification unit 3 is in the ON state. The use of such SPDT switch reduces the interference of one rear amplification unit with the input load of the other rear amplification unit during its ON state.

FIG. 9 is a block diagram showing a structure of a modification of the power amplifier 104 in the third embodiment.

Although the power amplifier of the above embodiment has two output terminals, it may have only one output terminal, as shown in FIG. 9, by adding a switch 16 for connecting the outputs of two rear amplification units 2 and 3 to the structure shown in FIG. 8. Furthermore, although the switch 16 in FIG. 9 is an SPST switch, it may be an SPDT switch.

Although the output of the input terminal 1 is divided into two in the above embodiment, it is possible to add rear amplification units of the number of the divided outputs so that the power amplifier of the present invention can be used for n (three or more) systems.

Although only one amplification unit (namely, a single-stage amplification unit) is included in each rear amplification unit of the above embodiment, it is possible to increase the number of stages, namely, to include n (two or more) amplification units, and therefore to increase the maximum output power level and expand the variable range of output power levels.

In addition, although the output of the input terminal 1 is divided in the above embodiment, the front amplification unit 10 may be provided between the input terminal 1 and the divided outputs thereof as shown in FIG. 4. By doing so, it becomes possible to increase the maximum output power level without increasing the number of stages of each rear amplification unit as well as to expand the variable range of output power levels.

### Fourth Embodiment

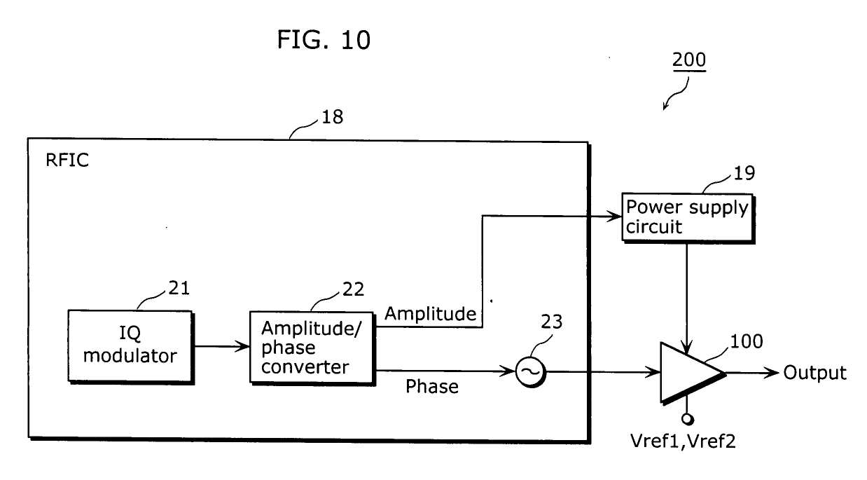

In the fourth embodiment of the present invention, a polar modulation system including the above-mentioned power amplifier in the first, second or third embodiment is described below with reference to FIG. 10.

FIG. 10 is a block diagram of a polar modulation system in the fourth embodiment of the present invention. The polar modulation system 200 as shown in FIG. 10 includes a radio frequency integrated circuit (RFIC) 18, a power supply circuit 19 and a power amplifier 100.

The RFIC 18 separates an IQ signal into amplitude information and phase information and outputs them. The RFIC 18 includes an IQ modulator 21, an amplitude/phase converter 22, and a voltage control oscillator 23.

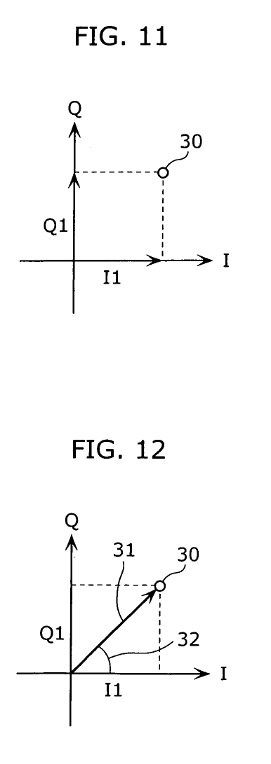

FIG. 11 is a diagram showing modulation of an IQ signal in the IQ modulator 21. As shown in FIG. 11, the IQ modulator 21 performs IQ modulation of digital data 30 and outputs it as an analog signal.

FIG. 12 is a diagram showing amplitude/phase conversion. The amplitude/phase converter 22 converts the IQ signal outputted from the IQ modulator 21 into amplitude information 31 and phase information 32 shown in FIG. 12, and then outputs them.

The voltage control oscillator 23 outputs a signal of predetermined frequency and phase based on the phase information (analog voltage) outputted from the amplitude/phase converter 22.

The power supply circuit 19 outputs a voltage corresponding to the amplitude information outputted from the amplitude/phase converter 22.

The power amplifier 100 is the power amplifier 100 shown in FIG. 2 and FIG. 3 and described in the first embodiment. Note that the power amplifier 100 may be the power amplifier described in the second or third embodiment. In the power amplifier 100, the signal including the phase information outputted from the voltage control oscillator 23 is inputted into the input terminal 1, and the voltage corresponding to the amplitude information outputted from the power supply circuit 19 is inputted into the VCC terminal. In addition, since the voltages to be applied to Vref1 and Vref2 are controlled, it becomes possible to switch the amplification unit to be used for the power amplifier 100 so that the optimum efficiency for the output power can be realized. Note that since the operation and effect of the power amplifier 100 are same as those of the first embodiment, the description thereof is not repeated here.

In designing a power amplifier suited to a system, it is necessary to conform three elements, namely, power, efficiency and linearity (distortion), to the system. Since the power amplifier 100 in the present embodiment performs nonlinear amplification of signals, there is no need to conform the element of linearity in the present polar modulation system. In other words, a polar modulation system that conforms to a plurality of systems can easily be designed by just using the power amplifier 100 in the polar modulation system.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a power amplifier and a polar modulation system, and particularly to a power amplifier used for a wireless communication device such as a cellular phone which communicates in a plurality of transmission modes of different power levels while switching the power level from mode to mode.

What is claimed is:

1. A power amplifier used in a communication device which communicates in a plurality of transmission modes of different power levels while switching the power level from mode to mode, said power amplifier comprising:
an input terminal to which a signal is inputted;
a first amplification unit operable to amplify the signal inputted to said input terminal to a signal of a first power level; and
a second amplification unit operable to amplify the signal inputted to said input terminal to a signal of a second power level which is different from the first power level,
wherein when one of said first amplification unit and said second amplification unit is turned on, the other is turned off.

2. The power amplifier according to claim 1,
wherein said first amplification unit and said second amplification unit are operable to perform nonlinear amplification of the signals; and
wherein said first amplification unit and said second amplification unit are each operable to output a signal of a desired power level according to control of a power supply voltage to be applied.

3. The power amplifier according to claim 2, further comprising:
an output terminal operable to output one of the signals amplified by said first amplification unit and said second amplification unit;
a first input matching unit operable to perform matching between an output impedance of a signal source which outputs the signal inputted to said input terminal and an input impedance of said first amplification unit;
a second input matching unit operable to perform matching between the output impedance of the signal source and an input impedance of said second amplification unit;
a first output matching unit operable to perform matching between an output impedance of said first amplification unit and an impedance of a load connected to said output terminal; and
a second output matching unit operable t perform matching between an output impedance of said second amplification unit and the impedance of the load.

4. The power amplifier according to claim 3,
wherein the input impedance of said first amplification unit is different from the input impedance of said second amplification unit; and
wherein the output impedance of said first amplification unit is different from the output impedance of said second amplification unit.

5. The power amplifier according to claim 4,
wherein said first amplification unit and said second amplification unit are operable to amplify signals used in the same transmission scheme.

6. The power amplifier according to claim 1,
wherein at least one of said first amplification unit and said second amplification unit is made up of amplification units in a multiple-stage structure.

7. The power amplifier according to claim 1, further comprising:
a first output terminal operable to output the signal amplified by said first amplification unit; and
a second output terminal operable to output the signal amplified by said second amplification unit.

8. The power amplifier according to claim 1, further comprising
an output terminal operable to output the signals amplified by said first amplification unit and said second amplification unit.

9. The power amplifier according to claim 8, further comprising
a switch which is connected between an output of said second amplification unit and said output terminal,
wherein an output of said first amplification unit is connected to said output terminal; and
wherein said switch is turned off when said first amplification unit is in an on-state, and turned on when said second amplification unit is in an on-state.

10. The power amplifier according to claim 8, further comprising
a switch which is connected between said output terminal and outputs of said first amplification unit and said second amplification unit,
wherein said switch connects said output terminal to one of the outputs of said first amplification unit and said second amplification unit.

11. The power amplifier according to claim 1, further comprising
a switch which is connected between said input terminal and at least one of inputs of said first amplification unit and said second amplification unit.

12. The power amplifier according to claim 1, further comprising:
an output terminal operable to output one of the signals amplified by said first amplification unit and said second amplification unit;
a first input matching unit operable to perform matching between an output impedance of a signal source which outputs the signal inputted to said input terminal and an input impedance of said first amplification unit;
a second input matching unit operable to perform matching between the output impedance of the signal source and an input impedance of said second amplification unit;
a first output matching unit operable to perform matching between an output impedance of said first amplification unit and an impedance of a load connected to said output terminal; and
a second output matching unit operable to perform matching between an output impedance of said second amplification unit and the impedance of the load.

13. The power amplifier according to claim 12,
wherein the input impedance of said first amplification unit is different from the input impedance of said second amplification unit; and
wherein the output impedance of said first amplification unit is different from the output impedance of said second amplification unit.

14. The power amplifier according to claim 1,
wherein said first amplification unit and said second amplification unit are each made up of one of a bipolar transistor and a field-effect transistor; and
wherein said first amplification unit and said second amplification unit are each controlled to be turned on or off according to control of one of a base voltage of the bipolar transistor and a gate voltage of the field-effect transistor.

15. The power amplifier according to claim 14,
wherein said first amplification unit and said second amplification unit each have a control terminal of one of the base voltage of the bipolar transistor and the gate voltage of the field-effect transistor.

16. The power amplifier according to claim 1, further comprising
a third amplification unit which is provided between said input terminal and inputs of said first amplification unit and said second amplification unit.

17. The power amplifier according to claim 1,
wherein said first amplification unit and said second amplification unit are operable to amplify signals used in the same transmission scheme.

18. The power amplifier according to claim 1, comprising
a plurality of amplification units which include at least said first amplification unit and said second amplification unit, and are operable to amplify the signal inputted to said input terminal to signals of power levels which are different from each other,
wherein when one of said plurality of amplification units is turned on, the other is turned off.

19. A polar modulation system comprising:
a radio frequency integrated circuit operable to separate an IQ signal into phase information and amplitude information, and to output the phase information and the amplitude information;
a power supply circuit operable to output a voltage corresponding to the amplitude information;
a first amplification unit operable to amplify the phase information to a signal of a first power level; and
a second amplification unit operable to amplify the phase information to a signal of a second power level which is different from the first power level,
wherein when one of said first amplification unit and said second amplification unit is turned on, the other is turned off; and
wherein the voltage outputted by said power supply circuit is inputted, as a power supply voltage, to said first amplification unit and said second amplification unit.

20. A method for controlling a power amplifier used in a communication device which communicates in a plurality of transmission modes of different power levels while switching the power level from mode to mode, said method comprising
turning on one of two amplification units operable to amplify the same signal to signals of power levels which are different from each other.
